(19) United States
(12) Patent Application Publication
(10) Pub. No.: US 2018/0011704 A1
(43) Pub. Date: Jan. 11, 2018

(54) DEVELOPMENT PLATFORM FOR MULTI-WIRELESS TRANSMISSION CAPABILITIES

(71) Applicant: SWIFT LABS INC., Kitchener (CA)

(72) Inventors: Anthony MIDDLETON, Kitchener (CA); Daniel RODRIGUES, Mississauga (CA); James LEGUE, Waterloo (CA); Doug MOWBRAY, Lakeside (CA)

(21) Appl. No.: 15/645,186

(22) Filed: Jul. 10, 2017

Related U.S. Application Data
(60) Provisional application No. 62/360,653, filed on Jul. 11, 2016.

(51) Int. Cl. G06F 9/44; H04B 1/38

(52) U.S. Cl. CPC G06F 8/71; G06F 8/30; H04B 1/38

(57) ABSTRACT

The disclosure is directed at a method and apparatus for product development. Many companies are trying to enter markets with new wireless products or by adding wireless connectivity to their existing products. Some of these companies develop the need to build customized hardware that meets specific requirements depending on the application. The system and method of the disclosure provides quicker hardware development cycles to create opportunities to bring products to market faster.

### REFERENCE TO RELATED APPLICATION

The application is a formal application based on and claiming the benefit of U.S. Provisional Application No. 62/360,653 filed Jul. 11, 2016, and hereby incorporated by reference.

### FIELD OF THE DISCLOSURE

The disclosure is generally directed at product development, and more specifically at a method and apparatus for product development.

### BACKGROUND OF THE DISCLOSURE

Many companies are trying to explore markets with new wireless products or by adding wireless connectivity to their existing products. Some of these companies develop the need to build customized hardware that meet specific requirements depending on the application. Additional to the typical challenges of building customized hardware, are the challenges of selecting an application-appropriate wireless technology, integrating wireless components into the design, and maintaining or improving device performance while minimizing cost, size and a degradation in user experience.

Successful wireless hardware design requires a strong understanding of the product use case requirements, especially pertaining to the wireless requirements, i.e. how much data to be wirelessly transmitted/received, how often will data be exchanged, what physical distance will the data need to travel over the air, what environmental factors will affect the transmission properties, how many devices are part of the wireless network, how long is each device expected to be powered, will expenses be incurred by data traffic over the network, etc. Some systems that collect and process data can require that different types of end-devices be communicated with, each with their own individualized system requirements. Existing solutions are restricted to limited performance metrics or removal of certain use cases altogether.

Further challenges can arise in the design phase as the number of available wireless technologies has grown substantially over the last several years, which gives a lot of flexibility from a design standpoint, but a lot of confusion in terms of which technology is the most suitable. On top of the wireless system requirements, additional factors such as world region, device count, and data costs can play into this decision. Designs with requirements that cross multiple of these avenues will require multiple skews of hardware for even a single frequency wireless transceiver solution. Thus, creating the requirement of a system that uses multiple coexisting wireless networks that can span different frequency domains and physical ranges.

In the development phase of the design, additional challenges arise of integrating wireless components into a new or existing design. Development of system software and application level design can only fully begin once the hardware has been qualified, which could take multiple board design revisions, and a variable number of resources, including design tools, designers and test equipment. As a product development cycle, the additional time required to overcome these challenges, increases the barrier to entry for solutions that require custom designs in a short period of time.

When data is collected from multiple end-devices, processing usually occurs, and with the thought of limiting the amount of data to be transferred to a cloud network, it can be favourable to process data in the local network prior to transferring the data. In a non-deterministic environment, the end-device data being transmitted can be changing and non-typical in many scenarios. Few devices can manage and handle this data traffic efficiently, with a constantly changing and updating environment.

Therefore, there is provided a novel method and apparatus for a development platform.

### SUMMARY OF THE DISCLOSURE

The disclosure is directed at a method and apparatus for product development. Many companies are trying to enter markets with new wireless products or by adding wireless connectivity to their existing products. Some of these companies develop the need to build customized hardware that meets specific requirements depending on the application. The system and method of the disclosure provides quicker hardware development cycles to create opportunities to bring products to market faster.

In one aspect of the disclosure, there is provided an apparatus for accelerating product development including a central processing unit; a wireless connectivity subsystem including a set of at least two transceivers for communicating wirelessly with external devices; and an external connectivity subsystem including a set of ports for enabling wired communication with the central processing unit.

In another aspect, the set of at least two transceivers are selected from a group including a GNSS receiver, a cellular LTE modem, a LoRa transceiver, a BT/WLAN transceiver and a Sub-1 GHz transceiver. In a further aspect, the system further includes a memory subsystem whereby the includes at least one of flash memory, RAM memory or an external microSD connector. In another aspect, the system includes a sensor subsystem whereby the sensor subsystem may include at least one of a movement sensor chip and a temperature sensor. In a further aspect, the movement sensor chip includes an accelerometer and a gyroscope.

In a second aspect of the disclosure, there is provided a method of code development for a proposed product including receiving a set of requirements for the proposed product; retrieving and displaying a set of hardware subsystems for the proposed product based on the set of requirements for the proposed product; receiving a set of development code for execution on the set of hardware subsystems; performing a simulation by executing the development code on the set of hardware subsystems; and displaying results of simulation.

In a third aspect of the disclosure, there is provided a system for development of code including a set of code development platform apparatus, each of the set of code development platform apparatus including a central processing unit; a wireless connectivity subsystem including a set of at least two transceivers for communicating wirelessly with external devices; and an external connectivity subsystem including a set of ports for enabling wired communication with the central processing unit; wherein one of the set of code development platform apparatus is seen as a back-end apparatus and the rest of the set of code development platform apparatus are seen as front-end apparatus; whereby the back-end apparatus communicates simultaneously with the front-end apparatus via the wireless connectivity subsystem to transmit information concerning development code simulations.

In another aspect, each of the front-end apparatus backhaul data to the back-end apparatus for analysis. In a further aspect, the back-end apparatus uses artificial intelligence or machine learning for the analysis. In yet a further aspect, one of the front-end apparatus receives and analyzes data and transmits the data and analysis to the other of the set of core development platform apparatus whereby the analysis may be performed using artificial intelligence or machine learning. In an aspect, the analysis is performed in a local configuration without Internet connectivity.

### BRIEF DESCRIPTION OF THE DRAWINGS

Embodiments of the present disclosure will now be described, by way of example only, with reference to the attached Figures.

FIG. 1 is a perspective view of an apparatus for product development;

FIG. 2 is a schematic diagram of an apparatus for product development;

FIG. 3 is a more detailed schematic diagram of an apparatus for product development;

FIG. 4 is a flowchart outlining a method of product development;

FIG. 5 is a flowchart outlining a method of product development; and

FIGS. 6a to 6c are schematic diagrams of a network of apparatus for product development.

### DETAILED DESCRIPTION OF THE DISCLOSURE

The disclosure is directed at a method and apparatus for multi-wireless channel communication or transmission. In one embodiment, the apparatus includes a wireless structure having a development platform that incorporates a computing platform, wireless radios, sensors and interfaces. The apparatus includes at least two different wireless radios, or transceivers, for communicating with other external devices.

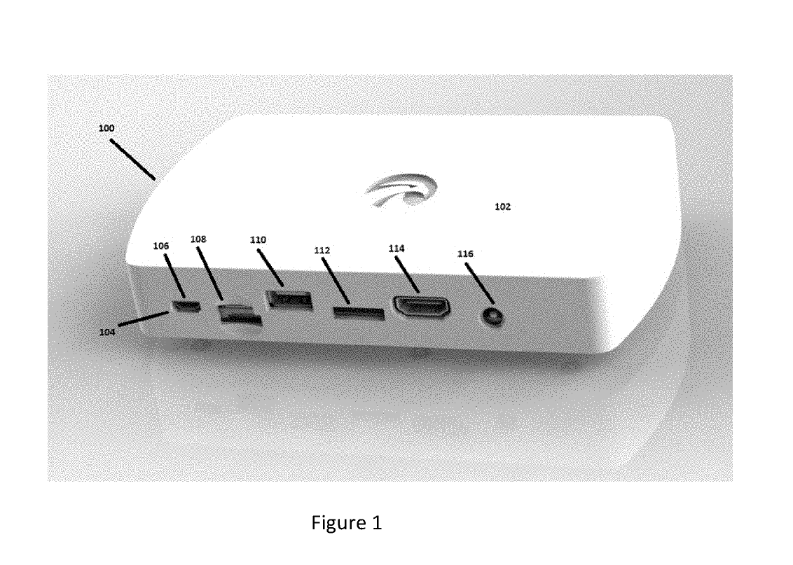

Turning to FIG. 1, a perspective view of apparatus for simultaneous multi-channel wireless communication, or a development platform, is shown. The apparatus 100 includes a housing 102 which houses the components for enabling the multi-channel wireless communication or transmission. The apparatus 100 further includes a set of ports 104 for receiving cables connecting the apparatus to other external devices. In the current embodiment, the set of ports 104 include a micro-USB port 106, a port for both a nano-SIM card or microSD card 108, a USB port 110, a port fora parallel interface camera 112, a high-definition multimedia interface (HDMI) port 114 and an external power connector 116. It will be understood that other types of ports are contemplated and that different arrangements and/or combination of ports are also possible and are not restricted to the set of ports 104 as schematically shown in FIG. 1.

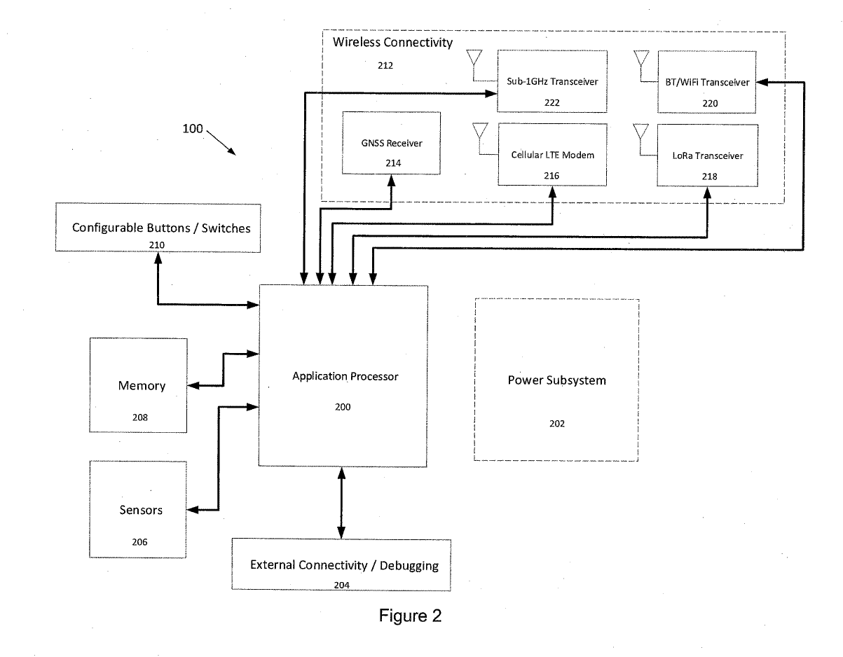

Turning to FIG. 2, a schematic diagram of apparatus for simultaneous multi-channel wireless communication is shown. In other words, FIG. 2 is directed at one embodiment of components integrated or stored within the housing of FIG. 1. In a preferred embodiment, the apparatus can be used for accelerating a product development process. This will be described in more detail below.

The apparatus 100 includes a processor, such as a central processing unit (CPU) 200 that is powered by a power subsystem 202. In a preferred embodiment, the processor 200 is a performance-based applications processor with an ARM® Cortex® A7 core to support algorithm and data processing. In preferred embodiments, various interfaces or protocols are used for communication between the processor 200 and the different components of the apparatus 100. Some examples include, but are not limited to, secure digital input output (SDIO), double data rate 3 low voltage synchronous dynamic random access memory (DDR3L SDRAM), quad serial peripheral interface (QSPI), 24-bit Parallel LCD, 8-bit Parallel Camera, universal asynchronous receiver/transmitter (UART), inter-integrated circuit (I²C), serial peripheral interface (SPI), controller area network bus (CANBUS), inter-IC Sound (I²S), Sony/Philips digital interface format (S/PDIF), USB2.0, joint tag action group (JTAG) and general-purpose input/output (GPIO) interfaces. The processor 200 supports power management features which include, but are not limited to, dynamic voltage frequency scaling (DVFS), clock gating, power islands, on-board power regulation and low power modes. The low power mode is preferably configured to achieve low or minimal power consumption, which in turn, reduces the overall temperature of the system. In one embodiment, the processor 200 has an integrated floating-point unit to accelerate floating point operations performed by the processing algorithm.

The processor 200 is also connected to apparatus for external connectivity 204 which include, or is associated with, the set of ports 104. The apparatus for external connectivity 204 may be used to allow wired communication between the apparatus 100 and external devices, such as, but not limited to, USB peripherals 362 (cameras, etc.), external displays 352, audio devices 360, and CAN bus network devices 358. A plurality of sensors 206 are also connected to the CPU 200 and provide various information such as, but not limited to, external conditions surrounding the apparatus, orientation of the apparatus, or stabilization. Memory 208 for storing data is also located within the housing 102. The system 100 further includes a set of buttons/switches 210 which may be used to assist in controlling or resetting the apparatus 100.

As shown in FIG. 2, the system further includes a wireless connectivity section, or apparatus 212 for enabling simultaneous multi-channel wireless communication between the apparatus 100 and other devices. The wireless connectivity section 212 includes a set of at least two different transceivers allowing the apparatus 100 to communicate with multiple external parties over different communication channels at the same time. In the current embodiment, the wireless connectivity section 212 includes a global navigation satellite system (GNSS) receiver 214, a cellular LTE modem 216, a long-range (LoRa) transceiver 218, a Bluetooth™/WiFi™ (BT/WiFi) transceiver 220 and a sub-1 GHz transceiver 222 although transceivers and other combination of transceivers are contemplated. Each of the transceivers 214 to 222 is individually connected to the CPU 200 such that the processor can independently communicate via the transceivers with the external devices or entities at the same time.

In one embodiment of operation, the integrated GNSS receiver 214 or GNSS receiver module functions to obtain a location fix for the apparatus 100. The receiver 214 includes an integrated antenna, filtering and matching circuitry as will be understood. In a preferred embodiment, the receiver 214 obtains the location fix based on multiple satellite constellations including, but not limited to, a Global Positioning System (GPS), a Global Navigation Satellite System (GLONASS), a satellite-based augmentation system (SBAS), and a Quasi-Zenith Satellite System (QZSS). The receiver 214 relies on UART communication to transfer incoming data to the CPU 200. In one embodiment, the receiver 214 operates in the 1575.42 MHz band. In order to reduce power consumption when the device location update is not necessary, the GNSS receiver 214 may be put into one of the low power tracking modes. The receiver 214 can also be set on a cyclic tracking frequency for short period wake-ups or set to an on/off mode for longer periods of low power operation.

In one mode of operation, the cellular LTE modem 216 or cellular radio is used to transmit data from the apparatus 100 to a wireless wide area network (WAN) infrastructure that may, for instance, store the data in the cloud to be retrieved by another device. In a preferred embodiment, the cellular LTE modem 216 has the functionality to download data from the network, including, but not limited to, OTA (Over-The-Air) software upgrades. The modem 216 may also include an externally accessible nano-SIM card slot. The cellular radio 216 preferably operates in the frequency bands that are allocated for LTE, 3G and 2G cellular networks which are typically within the range of 700 MHz to 2600 MHz.

In one embodiment, the apparatus 100 may include multiple LTE modems 216. As such, the different cellular modems 216 may be selected to provide different functional capabilities. These include low data rate LTE categories including, but not limited to, LTE Cat 1, LTE Cat M1, NB-IOT, etc. Also, in some embodiments, the multiple modems 216 may cover different frequency bands based on geographical regions, such as North America and Europe. In one embodiment, the modem 216 includes an integrated crystal oscillator, voltage regulator, matching circuitry, filtering and antenna. Communication between the modem 216 and the processor 200 is preferably via UART or USB2.0 communication lines.

In one embodiment of operation, the integrated LoRa transceiver 218 or transceiver module operates in the 915 MHz with low data rates for extended transmission distance. The transceiver 218 preferably has an integrated microcontroller, crystal, memory, radio transceiver, analog front-end circuitry and matching network as will be understood. The CPU 200 communicates with the LoRa module 218 via a standard UART interface.

In one mode of operation, the integrated Bluetooth/WLAN or WiFi combination module 220 operates in the 2.4 GHz frequency range for Bluetooth and 2.4 GHz and 5.0 GHz ranges for WLAN. In preferred embodiments, the Bluetooth portion, or Bluetooth radio, of the module 220 has dual-mode functionality of standard Bluetooth and Bluetooth low energy up to version 4.1 which includes BR/EDR (Basic Rate and Enhanced Data Rate). The CPU 200 preferably communicates to the WLAN subsystem via 4-bit SDIO and to the Bluetooth subsystem via 4-wire UART lines. The WLAN subsystem supports 802.11 a/b/g/n including MIMO via two on-board antennas.

In one embodiment, the Bluetooth radio is implemented such that the apparatus 100 transmits and receives data wirelessly to/from another Bluetooth enabled device for short-range data transfer, collects MAC address data to store for collection and tracking, and/or performs OTA software upgrades. Similarly, the WLAN subsystem has similar capability in terms of transferring data to an access point and receiving from one, as well as MAC address data collection, and OTA software upgrades.

In one mode of operation, the integrated Sub-1 GHz transceiver 222 operates in the 915 MHz frequency band with low data rates for extended transmission distance. The transceiver preferably includes an integrated core processor, such as an ARM® Cortex® M3 core processor, memory, radio transceiver, and peripheral communication interface modules. The transceiver 222 may also include the capability to operate in the 2.4 GHz frequency band to support Bluetooth low energy 4.2 specification, 802.15.4 g Zigbee, 6LoWPAN, and other related networks. The subsystem design requires external on-board analog front-end circuitry and matching network. An on-board antenna is also integrated into the design. The CPU 200 preferably communicates with the integrated sub-1 GHz transceiver 222 via a standard UART interface.

In one example, the GNSS receiver 214 can communicate with GPS satellites to obtain location information with respect to the presence of the apparatus while the cellular LTE modem 216 transmits or receives data over the Internet.

An advantage of the current disclosure is that for product testing purposes, an increased number of different technologies+frequencies that can cover more use cases, in terms of high/low data rates, close/long range communication, high/low power transmissions to connect many devices in a network are available within one system. For example, the system could be using Bluetooth for short range data collection from end node devices 600 in a local network, sending that to other gateways over a long range technology such as Sub-1 GHz, and then backhauling that data through a gateway 100 to the cloud network 604 via cellular.

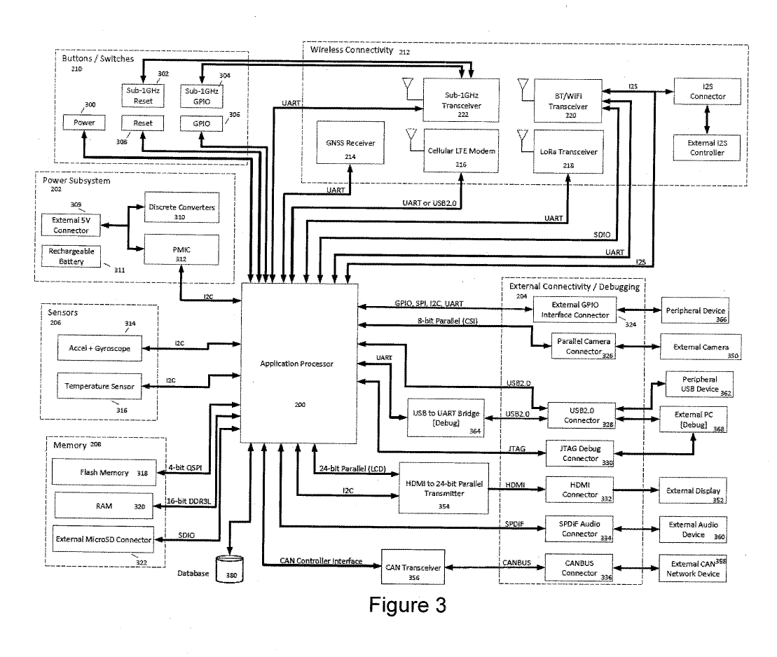

Turning to FIG. 3, a more detailed schematic of apparatus for multi-channel wireless communication is shown. In FIG. 3, certain of the components of the apparatus 100 are shown in more detail. The multi-channel wireless communication apparatus may also be seen as a development platform.

In the embodiment of FIG. 3, the buttons/switches preferably include a power button/switch 300, a Sub-1 GHz transceiver reset button 302 and a Sub-1 GHz GPIO 304 that are connected with the sub-1 GHz transceiver 222, a GPIO 306 that is connected to the CPU 200 and a reset button 308 that is also connected to the processor 200. The buttons and switches are provided internally to the housing but are preferably accessible with the lid opened.

In preferred embodiments, the apparatus, or wireless platform, includes multiple LEDs to provide indications of functionality of the unit. The message or indications can be configurable and be used to indicate examples such as the system being powered, battery states, wireless radio transmitting periods, and sensor capturing modes. Each LED has the required state definitions time-multiplexed within a set period such that each state can be identified simultaneously if each mode happens to be in operation at the same time.

The power subsystem 202 is preferably connected to an external power connector 309 for providing the necessary power to operate or charge the apparatus 100. Within the subsystem is a set of discrete converters 310 and a set power management integrated circuit (PMIC) 312 for controlling the power being supplied to the components of the apparatus 100 via the power connector 209. A rechargeable battery 311 is also located within the power subsystem.

In one embodiment, the power path includes an input from the external power source 309 that charges the internal rechargeable battery 311 that consequently, powers the system. The rechargeable battery 311 enables portable usage of the apparatus 100 when an external power source is not available. In a preferred embodiment, the apparatus 100 accepts a 5V charging input (seen as the external power source 309) to charge the battery 311. The charging or power subsystem 202 steps down the voltage from 5V to an appropriate voltage level to charge the battery 311. The charging system preferably has built-in protection for over-voltage, over-current and under-voltage. These values are determined by the charging system and correlate with the battery specifications. A preferred embodiment uses a battery 311 that is rated for industrial environments and extreme operating conditions. The input power is regulated through the PMIC 312 to deliver power to the various subsystems and components within the apparatus 100 through dedicated voltage rails for higher efficiency power utilization.

In the embodiment of FIG. 3, the sensors include a motion tracking sensor 314 including an accelerator and gyroscope combination along with a temperature sensor 316. Although only two different sensors are shown, other sensors are contemplated.

In one embodiment, the motion tracking sensor 314 integrates a 3-axis accelerometer and a 3-axis gyroscope such that motion in 6 different axes can be sensed. The sensor 314 provides functionality including, but not limited to, step counting, device movement, and augmented location tracking. The augmented location tracking functionality may serve as a companion device and substitute for the GNSS receiver 214 to track current location based on a previously known location in situations when the GNSS receiver 214 is placed in low power tracking modes or shutdown mode or if the receiver 214 is not able to acquire a signal from satellites.

With respect to the integrated ambient temperature sensor 316, the sensor 316 preferably provides up to 14-bit resolution of accuracy and is designed for accuracy over a large temperature range. It also requires very low current to operate and is thus an asset to the apparatus in that it has low or minimal impact to battery life and has low power requirements. The sensor data can be retrieved or transmitted to the processor 200 via an I²C communication interface.

Within the memory section, there is preferably a flash memory 318, RAM memory 320 and an external microSD connector 322 (associated with the microSD port 108). Use of the flash memory 318, such as NOR Flash, and the RAM memory 320, such as, for instance, DDR3L SDRAM, for storage purposes will be well understood by one skilled in the art. The external connector 322 allows an external device or memory card to be plugged into the apparatus 100.

In one embodiment, the RAM memory 320 has an approximate 4 Gb storage capacity and can run at speeds of up to 400 MHz and uses a dedicated 16-bit parallel data interface with 16-bit addressable storage locations. In another embodiment, the flash memory 318 has approximately 256 Mb of storage capacity and can run at speeds of up to 108 MHz in a single transfer rate mode. It will be understood that other storage capacities can be used and that the ones listed in this paragraph are merely suggestions. The communication interface between the flash memory 318 and the processor 200 is preferably via a 4-bit QSPI interface.

The microSD slot or port 108 accepts various storage sizes for microSD cards, and uses a 4-bit SDIO interface to transfer data to and receive data from the processor 200. In a preferred embodiment, the microSD stores the software image and loads the device to start up the system.

Turning to the external connectivity/debugging system, in one embodiment, the debugging system includes an external GIPO interface connector 324, a parallel camera connector 326, a USB2.0 connector 328, a JTAG debug connector 330, a HDMI connector 332, an SPDIF audio connector 334 and a CAN BUS connector 336. In some cases, the components within the external connectivity/debugging system are associated with or connected to the set of ports 104.

In preferred embodiments, the parallel camera connector 326 allows the apparatus 100 to be connected with an external camera 350. The connector 326 may include a 24-pin connector interface to provide external 8-bit parallel interface camera sensor module. The parallel camera connector 326 preferably supports video graphics array (VGA) resolution cameras (640×480) and various data formats including: RGB, YCbCr422, and CCIR656.

In one embodiment, the HDMI connector 332 can be used to connect the apparatus 100 to an external monitor or screen 352 to output data to the display 352. In a preferred embodiment, the apparatus 100 is capable of driving a display with up to WXGA resolution (1366×768). Since the output from the processor 200 is in the format of a 24-bit parallel interface, the apparatus 100 includes an on-board transmitter component 354 for converting this output into standard HDMI protocol or signals before being transmitted to the display to drive the external display.

With the CANBUS connector 336, the system 100 may include a CAN transceiver 356 between the processor 200 and the CAN BUS connector 336. The CANBUS connector 336 allows an external CAN network device 358 to be connected to the apparatus 100. A CAN controller module within the processor 200 communicates or operates with the CAN 2.0 B protocol and sends and receives data to/from the CAN transceiver 356. The transceiver 356 converts the data from the processor 200 to a differential signal to transmit onto the bus for other CAN nodes to receive.

The SPDIF audio connector 334 may be a generic 4-pin connector that enables an external audio device 360 to be connected to the apparatus 100 via a 2-wire SPDIF communication interface. Alternatively, or in combination, a further audio connector may also be a connector to enable an external audio device to connect to the apparatus that uses I²S as its communication protocol. External peripheral devices that can operate as a master or slave can be connected to the external connectors to transfer data. The I²S module of the processor is also tied into pins on the BT/WLAN module to support audio over the air via Bluetooth.

The USB2.0 connector 328 enables external devices including USB peripherals 362, such as a USB camera to be connected to the apparatus 100. In one embodiment, the USB Host (type A) connector 328 allows for the USB peripheral device 362 to connect to the host processor 200 to transfer data through the USB2.0 High Speed protocol at up to speeds of 480 Mbps. An additional connector may provide a control access port to an external device that uses one of the following communication protocols: I²C, SPI or UART. This may be enabled via a USB to UART bridge 364. The GPIO connector 324 may also be used to provide another layer of control or input to and from an external device 366. The JTAG connector 330 enables an external computer device 368 to be connected with the apparatus 100.

The apparatus of the disclosure further includes a database 380 which stores information, such as programming requirements, for different hardware subsystems and the characteristics of the components themselves. In one embodiment, the developer can enter information associated with a proposed product and the apparatus selects a “best set” of subsystems for the developer to use in developing their product. After selecting the different components, the developer can write program code and use the development platform of the disclosure to test the code against the selected components. In one embodiment, the development platform provides a software coding environment for a developer to use in developing code for their product without having to purchase the individual components.

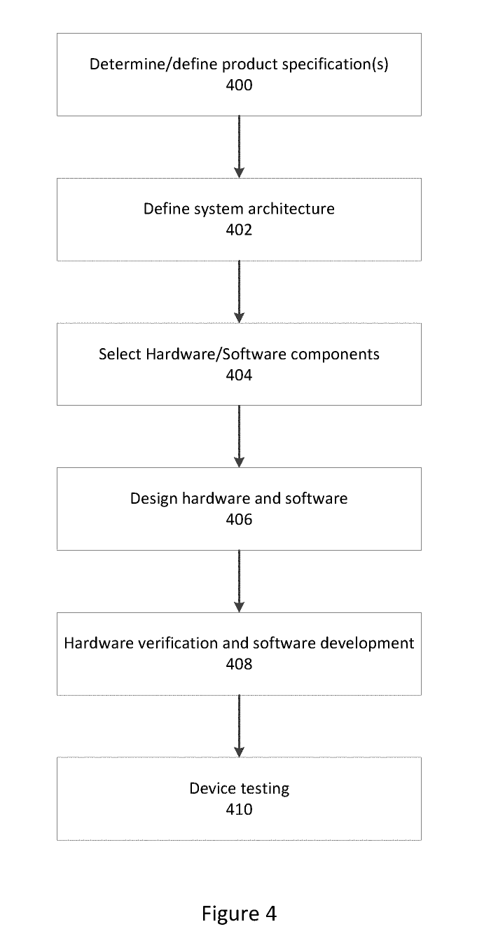

Turning to FIG. 4, a flowchart outlining a method of product development is shown. In this embodiment, the method is with regard to a developer. In one embodiment, the product may be an electronic device. The method of FIG. 4 is preferably used to design an electronic device having both hardware and software. Currently, it is a relatively long process between defining a product specification and having a physical device in the user's hands to test and further develop.

A developer or user initially determines or defines the product or prototype specification (400) based on a desired list of product features. The product specification controls the technical requirements and constraints that define the product. Based on the product specification, an overarching system architecture can be defined (402) which takes into account the interfacing of components to the processor and the power system to provide stable and sufficient power to each of the required peripheral subsystems. Hardware and related software component selection (404) can then be performed based on the defined system architecture.

After the components are selected, the hardware and the software is designed (406). In one embodiment, this may also include printed circuit board (PCB) design along with software drivers. After the hardware is designed, hardware verification and software development is performed. Once the PCBs are fabricated and populated with components, the hardware verification can start as well as any software development on top of the available drivers (408). The software is also subsequently developed and tested.

An advantage of the system is a reduction in time between the development of the initial requirements and having physical hardware available to begin software development is facilitated. For instance, using the system of the disclosure to add wireless connectivity to an existing device, a user could plug their device in via one of the external connectors or ports, when they are in the initial requirements/specification/architecture portion of the design flow and have hardware and software available to start testing. Currently, user need to qualify the hardware and software after being designed from the start which takes a lot more time.

After the software has met a sufficient level of maturity, device testing (410) can begin. Verification results can then be fed into the next revision of hardware.

Identifying compatible components from a feature requirements standpoint and interface perspective can be a difficult task for experienced and inexperienced designers alike. Selecting these components and integrating them into a single board design is improved by the apparatus of the disclosure from the viewpoint of a designer's development cycle. Having pre-defined hardware that is configurable through software with the specific components is an advantage over how it is currently performed. This is described in more detail below.

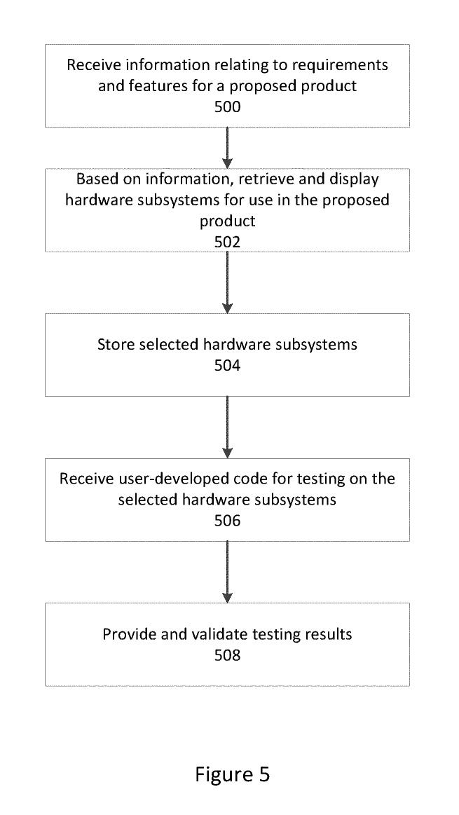

Turning to FIG. 5, another embodiment of a method of product development is shown. In this embodiment, the method is performed from the viewpoint of the apparatus.

The developer initially plugs their processing or computing device, such as a laptop and the like into the development platform via one of the ports 104 within the device, such as the micro-USB connector. After connecting with the apparatus 100, the developer can enter information relating to the requirements and select features, such as wireless communication requirements, that a developer needs for their product or the developer can enter information associated with a product they wish to produce. This information relating to requirements and features for a proposed product are received by the apparatus (500).

After receiving this information or input from a user or developer, the apparatus 100 determines or retrieves hardware subsystems for use in the proposed product (502). This list may be retrieved from a look-up table based on the entered information for selection by the developer or the developer may enter a list of suggested subsystems which may be reviewed by the development platform for things such as, but not limited to, compatibility with each other. Alternatively, the apparatus may determine suitable hardware subsystems based on the input from the developer.

After the subsystems are selected, the system stores the selected subsystems in memory within the apparatus 504. The developer can then write code for execution on the selected components and use the apparatus 100 to test or debug the written code 506. The system of the disclosure provides flexibility and multiple technology options in one integrated device.

The development platform provides an improved method of software code testing without a developer needing to purchase individual components and externally connect them, as the development platform provides a simulation environment for multiple subsystems concurrently. The results of the testing or simulation can then be displayed for the developer to review 508.

The apparatus of the disclosure reduces the number of actions to produce or arrive at a finished product. A developer can interact with the apparatus of the disclosure, which can also be seen as a development platform, to obtain information allowing for accelerated development of a product. In a preferred embodiment, the development platform is used for developers looking to develop products requiring wireless communication functionality. By providing a developer an apparatus that can execute test or source code without the need for a physical prototype of the product being built, allows for parallel development of both the hardware and software aspects of the product. The delay for a developer in waiting for a physical prototype to be manufactured before being able to test their code is shortened or reduced.

An advantage of the disclosure is that different components can be selected and tested at one time rather than having to test the written code individually on different components. As such, the developer can select multiple similar hardware subsystems for the simulation whereby the developer can determine with which hardware subsystems the developed code is more or most compatible.

After the code has been validated or reviewed, further product manufacture can be performed by the developer based on the subsystems selected or suggested by the development platform.

One advantage of the disclosure is that the apparatus provides access to unique combinations of hardware elements, firmware drivers and application-level software that allows users to begin their custom development immediately. This process flow allows the user to skip the first board design cycle and start directly with their custom software application development and device performance testing through use of the wireless platform. In parallel, this also allows the user to be able to determine the necessary changes required to alter the design towards the next revision of hardware with additional customized subsystems, components and mechanicals for their specific application. The overall timeline of the product development cycle can be reduced and thus allow the user to take their product to market sooner and more cost-effectively.

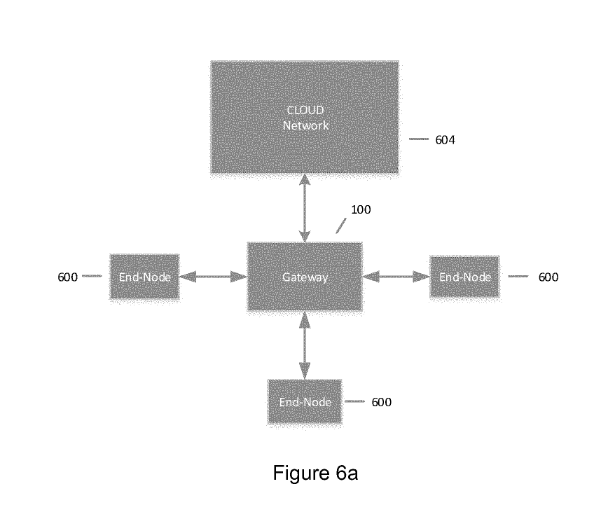

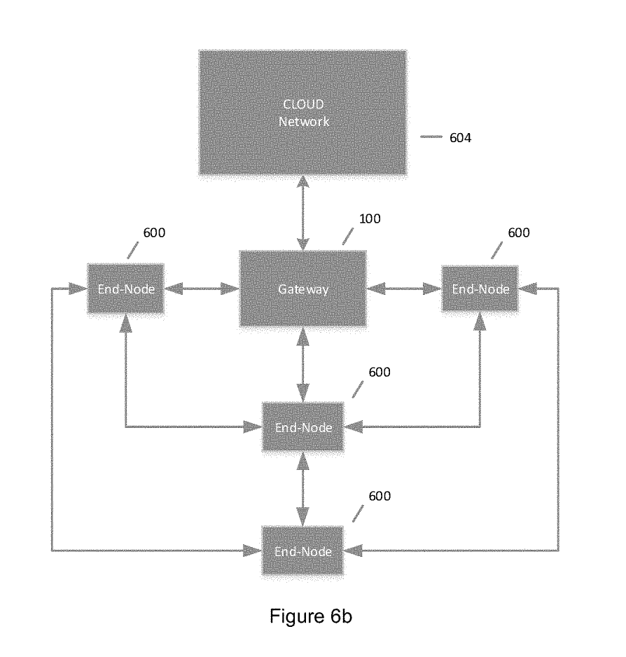

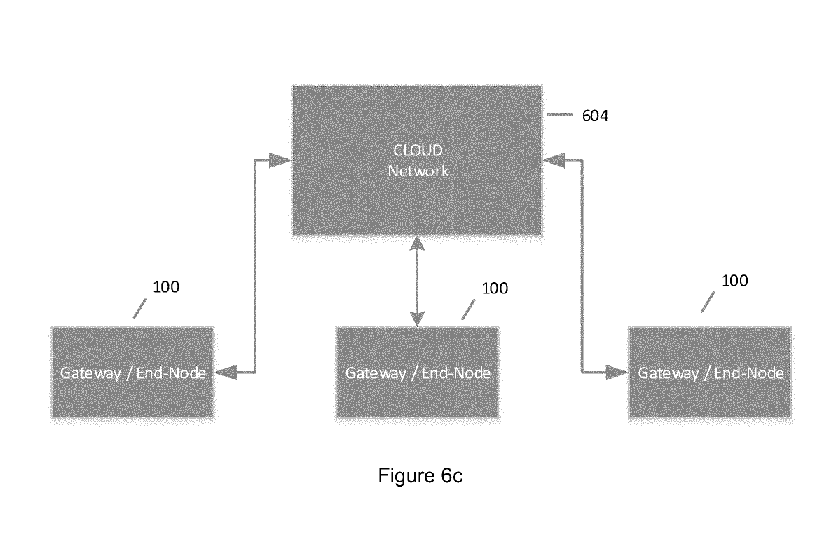

The wireless platform can be used as a development platform when incorporated in any of the preferred system architectural embodiments as seen in FIGS. 6a to 6c. FIG. 6a shows a typical configuration in which the apparatus performs the function of a gateway, such that it collects data from connected, either wirelessly or wired, end-nodes 600 (which can be seen as external devices or other apparatus 100), and then backhauls some, all, or a processed amount of data to a cloud environment 604. The data transfer will be performed after some analysis has been provided via a Machine Learning/Artificial Intelligence layer. Use of these layers will be understood by one skilled in the art. FIG. 6b shows another system architecture embodiment that allows end-node devices 600 to pass data through one another in a local area network to reach a gateway, seen as the apparatus 100 that may not be within the transmission range of a distant end-node device. Once again, the gateway 100 provides the connection to backhaul data to the cloud environment 604 to transfer data. FIG. 6c shows a system network in which each end-node (which can now be seen as the apparatus 100) has the technological capability to backhaul data to the cloud 604, thus making each end-node its own gateway 100.

As such, the apparatus 100 can support Edge or Fog computing. In a Fog computing instance, multiple apparatus 100 communicate together utilizing any number of the wireless radios available to gather data, backhaul to a single device that will analyze data locally. In an edge computing instance, a plurality of apparatus 100 are placed in a mesh network scenario such that data received in the network of apparatus can be used as an input and analysis made (using Al/ML) and distributed to each of the other edge devices.

In one embodiment, the apparatus can backhaul data in different ways. For instance, for an apparatus using Thread/Zigbee, the sub-1 GHz radio or the BT transceiver, data processing can be performed by the apparatus and then the data pushed to the cloud via a high bandwidth cellular modem. In another embodiment, to an existing internet connected device, the data processing can be performed in the cloud environment. In another embodiment, to the cloud using a lower bandwidth cellular radio or LoRa, the data processing can be done by the cloud environment.

In another embodiment, the apparatus operates locally without Internet connectivity. In this manner, one or more apparatus 100 in different configurations is/are able to control end point (or edge) apparatus in the local network by processing their input data, analyzing it with artificial intelligence and/or machine learning and making a decision on how to deterministrically change the network parameters to better suit the network's needs.

As a development tool, the apparatus can be configured as a subset of integrated subsystems in order to provide the development environment of a device with backhaul capability or as a device with local area network wireless transmission capabilities.

A preferred embodiment of the disclosure, or wireless platform, provides a low power microcontroller capable of, but not limited to, communicating with the data collection sensor components to extract data at a specified frequency to upload into a memory storage location. The microcontroller uses multiple interfaces to communicate with the peripheral components, that include, but are not limited to, UART, I2C, SPI, and GPIOs. The microcontroller implements a specific schedule to place components into low power modes when not active to reduce the power consumption. The low power modes are used frequently to ensure that minimal power consumption is achieved, which in turn, reduces the overall temperature of the board and internal device temperature.

Fog computing can be perceived both in large cloud systems and big data structures, making reference to the growing difficulties in accessing information objectively. This results in a lack of quality of the obtained content. The effects of fog computing on cloud computing and big data systems may vary; yet, a common aspect that can be extracted is a limitation in accurate content distribution, an issue that has been tackled with the creation of metrics that attempt to improve accuracy.

Fog networking includes a control plane and a data plane. For example, on the data plane, fog computing enables computing services to reside at the edge of the network as opposed to servers in a data-center. Compared to cloud computing, fog computing emphasizes proximity to end-users and client objectives, dense geographical distribution and local resource pooling, latency reduction and backbone bandwidth savings to achieve better quality of service (QoS) and edge analytics/stream mining, resulting in superior or improved user-experience and redundancy in case of failure.

Edge computing pushes applications, data and computing power (services) away from centralized points to the logical extremes of a network. Edge computing replicates fragments of information across distributed networks of web servers, which may spread over a vast area. As a topological paradigm, edge computing is also referred to as mesh computing, peer-to-peer computing, autonomic (self-healing) computing, grid computing, and by other names implying non-centralized, nodeless availability.

Although the present disclosure has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present disclosure.

In the preceding description, for purposes of explanation, numerous details are set forth in order to provide a thorough understanding of the embodiments. However, it will be apparent to one skilled in the art that these specific details may not be required. In other instances, well-known structures may be shown in block diagram form in order not to obscure the understanding. For example, specific details are not provided as to whether elements of the embodiments described herein are implemented as a software routine, hardware circuit, firmware, or a combination thereof.

Embodiments of the disclosure or components thereof can be provided as or represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor or controller to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor, controller or other suitable processing device, and can interface with circuitry to perform the described tasks.

What is claimed is:

1. An apparatus for accelerating product development comprising:
a central processing unit;
a wireless connectivity subsystem including a set of at least two transceivers for communicating wirelessly with external devices; and
an external connectivity subsystem including a set of ports for enabling wired communication with the central processing unit.

2. The apparatus of claim 1 wherein the set of at least two transceivers are selected from a group consisting of: a GNSS receiver, a cellular LTE modem, a LoRa transceiver, a BT/WLAN transceiver and a Sub-1 GHz transceiver.

3. The apparatus of claim 1 further comprising a memory subsystem.

4. The apparatus of claim 3 wherein the memory subsystem comprises at least one of flash memory, RAM memory or an external microSD connector.

5. The apparatus of claim 1 further comprising a sensor subsystem.

6. The apparatus of claim 5 wherein the sensor subsystem comprises at least one of a movement sensor chip and a temperature sensor.

7. The apparatus of claim 6 wherein the movement sensor chip comprises:
an accelerometer; and
a gyroscope.

8. A method of code development for a proposed product comprising:
receiving a set of requirements for the proposed product;
retrieving and displaying a set of hardware subsystems for the proposed product based on the set of requirements for the proposed product;
receiving a set of development code for execution on the set of hardware subsystems;
performing a simulation by executing the development code on the set of hardware subsystems; and
displaying results of simulation.

9. A system for development of code comprising:
a set of code development platform apparatus, each of the set of code development platform apparatus including:
a central processing unit;
a wireless connectivity subsystem including a set of at least two transceivers for communicating wirelessly with external devices; and
an external connectivity subsystem including a set of ports for enabling wired communication with the central processing unit;
wherein one of the set of code development platform apparatus is seen as a back-end apparatus and the rest of the set of code development platform apparatus are seen as front-end apparatus;
whereby the back-end apparatus communicates simultaneously with the front-end apparatus via the wireless connectivity subsystem to transmit information concerning development code simulations.

10. The system of claim 9 wherein each of the front-end apparatus backhaul data to the back-end apparatus for analysis.

11. The system of claim 10 wherein the back-end apparatus using artificial intelligence or machine learning for the analysis.

12. The system of claim 9 wherein one of the front-end apparatus receives and analyzes data and transmits the data and analysis to the other of the set of core development platform apparatus.

13. The system of claim 12 wherein the analysis is performed using artificial intelligence or machine learning.

14. The system of claim 11 wherein the analysis is performed in a local configuration without Internet connectivity.
